(19) United States
(12) Patent Application Publication
(10) Pub. No.: US 2009/0309645 A1
(43) Pub. Date: Dec. 17, 2009

(54) SWITCHED CAPACITOR APPARATUS PROVIDING INTEGRATION OF AN INPUT SIGNAL

(75) Inventors: Philip O. Isaacson, Chanhassen, MN (US); Josh D. Schilling, Eden Prairie, MN (US)

Correspondence Address: SCHWEGMAN, LUNDBERG & WOESSNER, P.A., P.O. BOX 2938, MINNEAPOLIS, MN, 55402, US

(73) Assignee: Nonin Medical, Inc., Plymouth, MN (US)

(21) Appl. No.: 12/483,428

(22) Filed: Jun. 12, 2009

Related U.S. Application Data
(60) Provisional application No. 61/061,454, filed on Jun. 13, 2008.

(51) Int. Cl. G06G 7/18

(52) U.S. Cl. 327/337

(57) ABSTRACT

An apparatus includes an operational amplifier, a switched capacitor network, an optical sensor, and a clock. The switched capacitor network is coupled to an input terminal of the operational amplifier and coupled to an output terminal of the operational amplifier. The optical sensor includes a sensor output coupled to the switched capacitor network. The clock is coupled to at least one switch of the switched capacitor network. The clock is configured to activate the at least one switch to provide an integrated output at the output terminal corresponding to the sensor output.

### CLAIM OF PRIORITY

The present application claims the benefit under 35 U.S.C. 119(e) of U.S. Provisional Patent Application Ser. No. 61/061,454, filed Jun. 13, 2008, which is incorporated herein by reference in its entirety.

### TECHNICAL FIELD

The present subject matter relates to an apparatus which is capable of integration while allowing periodic readout and reset functions, and more particularly to an integrator which is capable of integrating an input charge and enabling a readout and reset of the integrator while minimizing switching noise.

### BACKGROUND

### Integrator Circuits

An integrator utilizing an operational amplifier requires a capacitive element with capacitance C to act as a feedback path from the output of the operational amplifier to its inverting input. A resistive element with resistance R is connected in series between the input voltage to be integrated and said inverting input of the operational amplifier. The time constant for such an integrator is simply RC. All operational amplifiers inherently have voltage offsets present on their input and output terminals due to finite component mismatches. The magnitude of each of these voltage offsets is a unique characteristic of each individual operational amplifier and is a source of error in each operational amplifier output signal. Integrators fabricated utilizing MOS techniques have been constructed utilizing switched capacitors in place of resistive elements. Switched capacitor integrators constitute an improvement over integrators utilizing resistive elements due to the fact that resistance values of diffused resistors are not highly controllable in MOS circuits while the ratios of capacitance values are more controllable.

### Optical-Based Physiological Sensor Devices

There exists a wide range of devices that depend upon the transmission of optical signals to monitor or measure various biological or environmental parameters of a patient. For example, various forms of blood oximetry devices employ the transmission and reception of signals in the measurement of one or more biological or environmental parameters of a patient.

Blood oximetry devices are commonly used to monitor or measure the oxygen saturation levels of blood in a body organ or tissues, including blood vessels, or the oxidative metabolism of tissues or organs. An example of an optical oximeter is disclosed in U.S. Pat. No. Re 33,643, entitled “Single Channel Pulse Oximeter.” These devices are also often capable of and are used to determine pulse rate and volume of blood flow in organs or tissues, or to monitor or measure other biological or environmental parameters.

A blood oximetry device measures the levels of the components of one or more signals of one or more frequencies as transmitted through or reflected from tissue or an organ to determine one or more biological or environmental parameters, such as blood oxygenation level and blood volume or pulse rate of a patient.

Blood oximetry devices may also be constructed as directly connected devices, that is, devices that are directly connected to a patient and that directly present the desired information or directly record the information, and as remote devices, that is, devices attached to a patient and transmitting the measurements to a remote display, monitoring or data collection device.

Blood oximetry devices measure blood oxygen levels, pulse rate and volume of blood flow by emitting radiation in a frequency range, such as the red or near infrared range, wherein the transmission of the radiation through or reflectance of the radiation from the tissues or organ is measurably affected by the oxygen saturation levels and volume of the blood in the tissues or organ. A measurement of the signal level transmitted through a tissue or organ or reflected from a tissue or organ may then provide a measurement or indication of the oxygen saturation level in the tissue or organ. The transmitted or reflected signals may be of different frequencies which are typically affected in measurably different ways or amounts by various parameters or factors or components of the blood.

Parameters represented by transmitted or reflected signals may be represented by different and related or unrelated parameters of the received signals. For example, a signal transmitted through or reflected from tissue or an organ to measure, for example, blood oxygenation or flow, may have a constant or “dc” component due to the steady state volume of blood in the tissue or organ and a time varying or “ac” component indicative of the time varying volume of blood flowing through the tissue or organ due to the heart beat of the body. Each signal component may provide different information, and may provide information that may be used together to generate or determine further information.

### SUMMARY

The present subject matter is directed to a switched capacitor integrator finding particular suitability within a physiological sensor. The switched capacitor provides an improved solution to reducing the overhead of components while allowing application to custom or reconfigurable environments. Errors in gain variation are substantially reduced as the effect of clock drifts or jitters is minimized. Pulse oximetry is one application where embodiments of the present subject matter are particularly suitable.

The foregoing has outlined rather broadly the features and technical advantages of the present subject matter in order that the detailed description that follows may be better understood. Additional features and advantages will be described hereinafter. It should be appreciated by those skilled in the art that the conception and specific embodiment disclosed may be readily utilized as a basis for modifying or designing other structures for carrying out the same purposes of the present subject matter. It should also be realized by those skilled in the art that such equivalent constructions do not depart from the spirit and scope of the subject matter. The novel features which are believed to be characteristic of the subject matter, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present subject matter.

### BRIEF DESCRIPTION OF THE DRAWINGS

FIG. 1 is a schematic illustration of an integrator.

FIG. 2 is a schematic illustration of a switched capacitor resistor equivalent.

FIG. 3 is a schematic illustrations of a circuit equivalent to the integrator shown in FIG. 1 utilizing switched capacitor resistor equivalents.

FIG. 4 is an illustration of periodic clock signals suitable for use with the circuit of FIG. 3.

FIG. 5 is an illustration of an embodiment of a switched capacitor integrator in accordance with one example.

FIG. 6 is a diagrammatic representation of an embodiment of the present subject matter utilizing a mixed signal processor to control LED drive discretes and sensor LEDs.

FIG. 7 is an example of a front end signal path of a device implementing the present subject matter.

FIG. 8 is an illustration of a switched capacitor integrator in accordance with one embodiment of the present subject matter.

FIG. 9 is an illustration of clock signals, Φ₁ and Φ₂, suitable for use with the circuit of FIG. 8.

### DETAILED DESCRIPTION

### Integrators

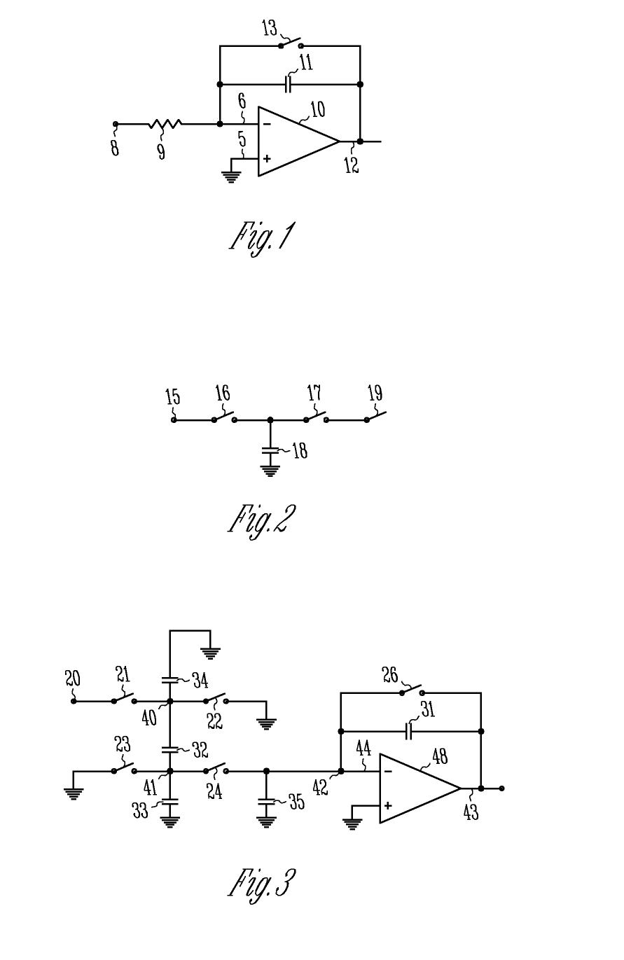

An integrator is shown in FIG. 1. Operational amplifier 10 is used in the inverting mode with capacitor 11 supplying negative feedback from operational amplifier output 12 to inverting input 6. The input voltage to be integrated is applied to the inverting input 6 of operational amplifier 10 through resistor 9 from terminal 8. If resistor 9 has a resistance value of R and capacitor 11 has a capacitance value C, the time constant, T, for this integrator is given by the equation:

T=RC

Switch 13 is connected in parallel across capacitor 11 in order to initialize the integrator by discharging capacitor 11. An ideal operational amplifier 10 will always have inverting input 6 at the same potential as noninverting input 5, which is connected to ground in the circuit of FIG. 1. An ideal operational amplifier will therefore have its output terminal 12 at ground potential as well. Thus, after initialization has been completed by discharging capacitor 11 through closed switch 13, an ideal operational amplifier connected as shown in FIG. 1 may begin integrating the voltage applied at terminal 8, and the result of the integration will appear at output terminal 12 of operational amplifier 10.

When embodying the integrator of FIG. 1 in an integrated circuit, the resistor and capacitor of the integrator have significant accuracy errors. These errors vary substantially with the operation environment, such as manufacturing process, temperature and use time, making it difficult to obtain accurate and reliable frequency characteristics. Therefore, in order to solve the above problem of the integrated circuit, there has been introduced a switched capacitor circuit illustrated in FIG. 3. Such a switched-capacitor circuit can be readily integrated on a single chip through the use of modern MOS manufacturing processes and has advantages of removing resistors and reducing power consumption.

As mentioned, in the construction of MOS semiconductor devices, values of resistors and capacitors are not highly controllable. Thus in the integrator circuit shown in FIG. 1 with the time constant equal to RC, circuits constructed utilizing MOS techniques will result in highly uncontrollable time constants.

In practice, resistors are generally formed by diffusion, resulting in resistance values and resistance ratios which are not highly controllable. Capacitors, on the other hand, are formed by utilizing layers of conductive material, such as metal or polycrystalline silicon, as capacitor plates. Each plate of conductive materials is separated by a layer of electrical insulation material, such as SiO₂ or silicon nitride, serving as a dielectric, from another conductive layer or from a conductive substrate. While capacitor areas are quite controllable, dielectric thickness is not. Thus, while capacitance values are not highly controllable, ratios of capacitance values are, since dielectric thickness is quite uniform across a single semiconductor die.

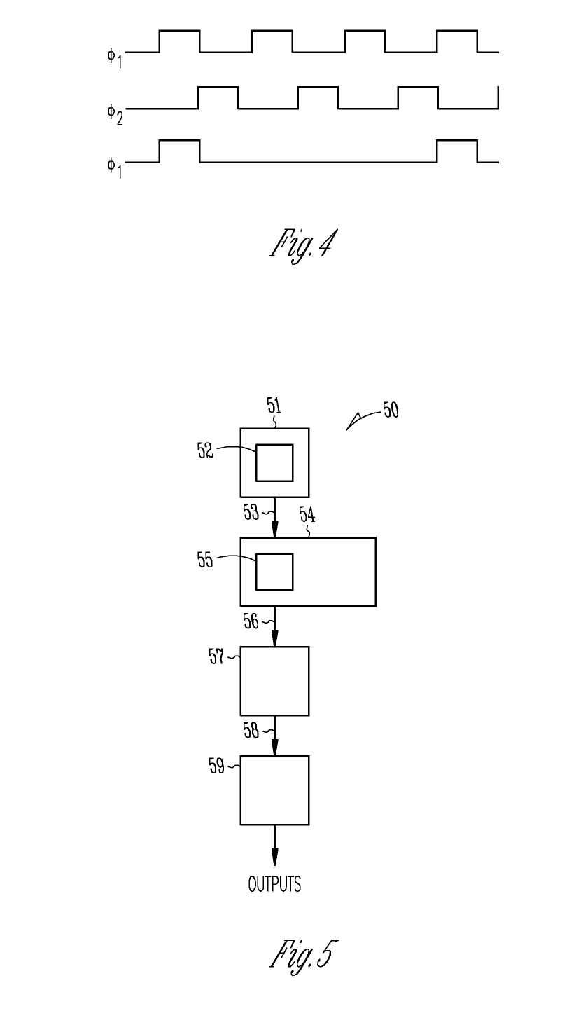

A switched capacitor resistor equivalent is shown in FIG. 2. Terminals 15 and 19 are available as equivalents to the terminals available on a resistor. Capacitor 18 has a capacitance value of C. Switch 16 is connected in series between input terminal 15 and capacitor 18, and controls when the input voltage is applied to capacitor 18 from terminal 15.

Switch 17 is connected in series between output terminal 19 and capacitor 18, and controls when the voltage stored in capacitor 18 is applied to output terminal 19. In practice, switches 16 and 17 are controlled by two clock generators having the same frequency of operation but generating non-overlapping control pulses. When the clock controlling switch 16 goes high, switch 16 closes, thus causing capacitor 18 to be charged to the input voltage applied to terminal 15. Because the two clock generators are non-overlapping, switch 17 is open during this charge cycle. Switch 16 then opens. Then switch 17 closes, while switch 16 remains open, thus applying the voltage stored on capacitor 18 to terminal 19. This resistor equivalent circuit of FIG. 2 simulates a resistor having resistance value R by the following equation:

R=t/CR

where t is the period of switches 16 and 17, in seconds, and CR is the capacitance of resistor equivalent capacitor 18. From these equations we can see that the time constant for the integrator of FIG. 1 utilizing a switched capacitor as a resistor equivalent will be:

T=C/CR

Since the time constant of an integrator utilizing a switched capacitor as a resistor equivalent is dependent on the ratio of capacitors, it is possible to construct many devices having a uniform capacitance ratio and thus uniform time constants.

A circuit equivalent to the integrator shown in FIG. 1 utilizing switched capacitor resistor equivalents is shown in FIG. 3. Capacitor 31 having capacitance value of C₁ provides negative feedback from output terminal 43 to inverting input terminal 44 of operational amplifier 48. Switch 26 is connected in parallel across capacitor 31 to provide means for discharging capacitor 31 and thus reinitializing the integrator. The non-inverting input terminal of operational amplifier 48 is connected to ground. Capacitor 32 together with switches 21, 22, 23 and 24 provide the switched capacitor resistor equivalent. Capacitor 32 has a capacitance value of C₂. Capacitors 33 and 34 are connected between node 41 and ground and between node 40 and ground, respectively, in order to attenuate the effects of noise impulses generated when switches 21, 22, 23 and 24 open. Capacitor 35 is connected between node 42 and ground in order to further attenuate the effects of noise impulses generated when switch 24 opens.

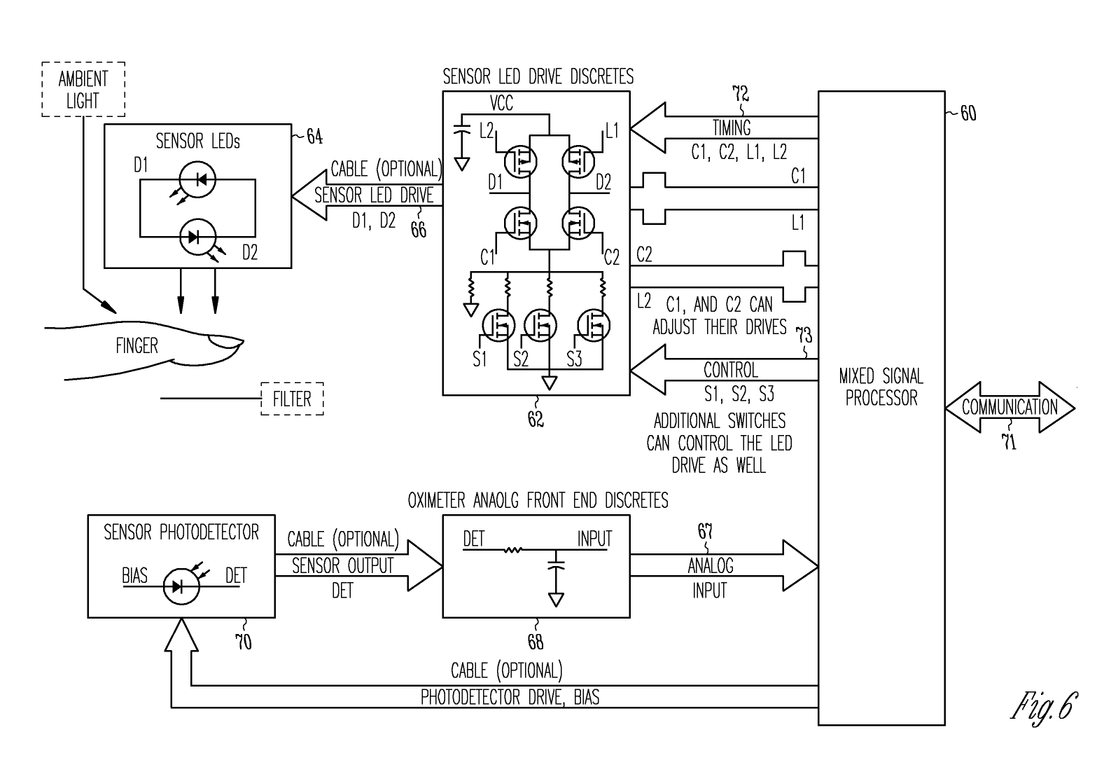

The operation of the circuit of FIG. 3 requires three separate control signals. Periodic clock signals suitable for this purpose are shown in FIG. 4. Φ₃ is used to drive switch 26. For each positive going pulse of Φ₃, switch 26 is closed, thereby discharging capacitor 31 and reinitializing the integrator. The frequency of Φ₁ is equal to an integral multiple of that of Φ₃. As shown in FIG. 4 however, while Φ₂ has the same frequency as Φ₁, it is delayed in such a manner that Φ₁ and Φ₂ are nonoverlapping clock signals of the same frequency.

During operation of the circuit of FIG. 3, both Φ₁ and Φ₃ go high at the same time as shown in FIG. 4. Φ₃ controls switch 26 such that a positive going pulse on Φ₃ will cause switch 26 to close, thus discharging capacitor 31 and reinitializing the integrator. Φ₁ controls switches 21 and 23 such that a positive going pulse on Φ₁ causes switches 21 and 23 to close. Φ₂ controls switches 22 and 24 such that a positive going pulse on Φ₂ causes switches 22 and 24 to close. During the reinitialization period of the integration cycle, Φ₁ is high, Φ₂ is low and Φ₃ is high. Thus switch 26 is closed, switches 21 and 23 are closed and switches 22 and 24 are open. Switch 26 shorts out capacitor 31 causing it to discharge. Furthermore, the voltage appearing at output terminal 43 of operational amplifier 48 is connected to the inverting input terminal of operational amplifier 48 forcing the voltage on inverting terminal 44, and thus charging capacitor 35 to V_{OFF}, the magnitude of the offset voltage of operational amplifier 48. At the same time capacitor 32 is charged to V_{IN}, the input voltage is applied to terminal 20.

### Application of Integrators in Medical Devices

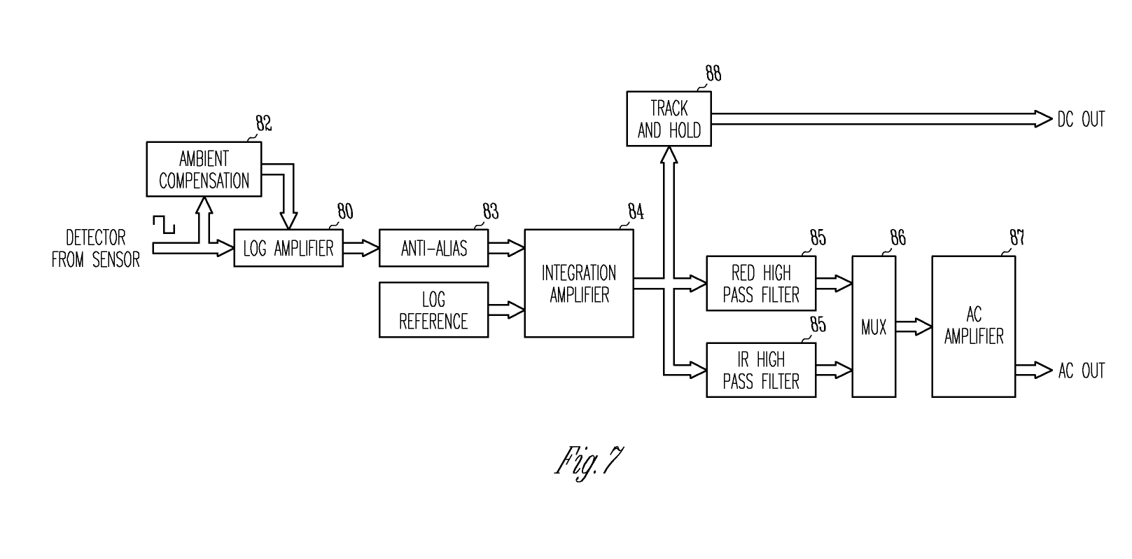

An embodiment of a switched capacitor integrator is disclosed herein with reference to an oximeter system 50 of FIG. 5. Device 50 includes a light source 51 which contains one or more light emitters 52 for generating corresponding light signals 53. Light signals 53 are transmitted through or reflected from a tissue field, such as finger 54, an organ or other body parts having parameters 55 which are to be measured or monitored. It is envisioned that embodiments of the present subject matter would be suitable in other physiologic data acquisition devices. As a result, the subject matter is not limited to the application of pulse oximeters.

The light signals 53 that are transmitted through or reflected from the tissue field 54 are received as modulated signals 56 by sensors 57. Sensors 57 in turn provide received signals 58 that correspond to and represent modulated signals 56 and the components and characteristics of modulated signals 56 due to modulations and modifications imposed on or induced in emitted signals 53 due to parameters 55.

Received signals 58 contain information relating to parameters 55 of the tissue field 54, and that information can be extracted or otherwise obtained from received signals 58 by appropriate signal processing. Such processing may include, for example, comparing components of the received signals 58 with those of light signals 53 or detecting and extracting components of received signals 58, such as the “dc” and “ac” components of the signal or signals.

The processing of received signals 58 to obtain the desired information comprising or pertaining to parameters 55 is performed by a signal processor 59, which provides parameter outputs which may be displayed, stored for later display or subsequent processing, or transmitted to another facility or system.

The specific process and algorithms by which received signals 58 are processed to generate parameter outputs representing the desired information are dependent upon the specific parameters 55 and tissue fields 54 of interest. These factors, elements and processes are, however, well known to and understood by those of skill in the relevant arts and the adaptation of the present subject matter to different ones and different combinations of these factors, elements and processes will be well understood by those of skill in the relevant arts. As such, these elements need not and will not be discussed in further detail herein.

FIG. 6 is a diagrammatic representation of an embodiment of the present subject matter utilizing a mixed signal processor 60 to control LED drive discretes 62 and sensor LEDs 64 via, for example, optional LED drive cable 66. Processor 60 also receives parameter signals 67 from analog front end discretes 68 as received from photodetector 70. Processor 60 may be in communication with another processor and/or remote device, via for example channel 71. Processor 60 provides timing signal 72 and control signals 73 to sensor LED drive discretes 62.

In one embodiment of the present subject matter, processor 60 includes an application-specific-integrated-circuit (ASIC). Advantages of an ASIC-based device include significant cost savings as fewer discrete components are required, minimizing the opportunity of reverse engineering, reduced assembly and test time, increased flexibility of component placement, and potential power savings. In alternative embodiments, processor 60 may include a variety of analog and/or digital components as appreciated by one of ordinary skill in the art.

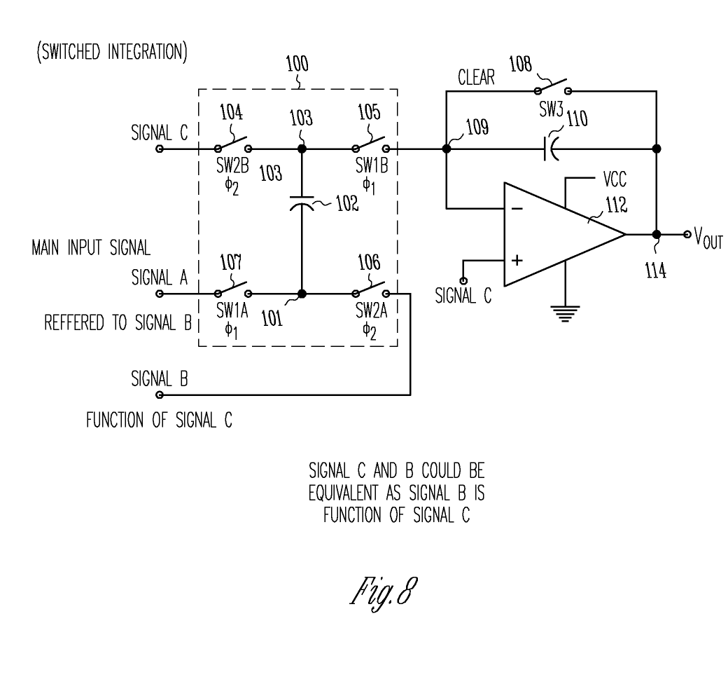

FIG. 7 is an example of a front end signal path of a device implementing an example of the present subject matter. The front end includes an input current-to-log amplifier 80, and ambient light current track/hold amplifier 82 together receiving an input signal from a sensor. The front end signal path also includes an anti-alias filter 83, an integration amplifier 84, a dual channel high pass filter 85, a multiplexor 86, a voltage amplifier 87 and a track/hold DC voltage amplifier 88. Outputs of the front end include DC out and AC out. Integration amplifier 84 operates to integrate an input signal. Additional disclosure is provided in applicant's pending U.S. Provisional Application Ser. No. 61/058,390, entitled “LED Control Utilizing Ambient Light or Signal Quality,” and being incorporated by reference herein.

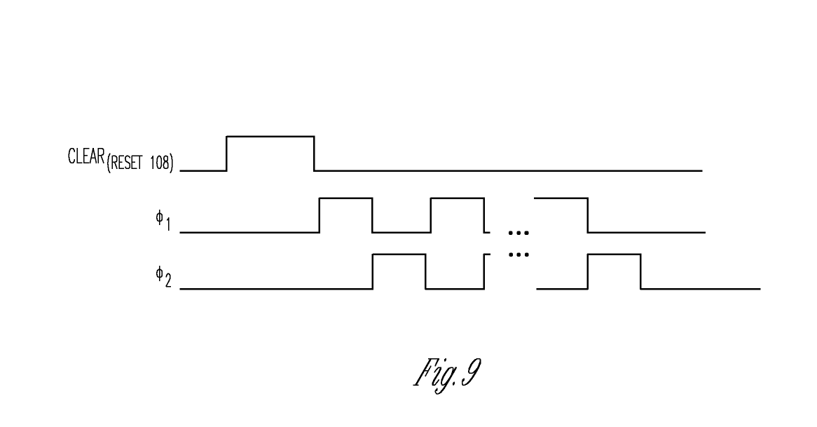

Referring to FIG. 8, there is illustrated a switched capacitor integrator in accordance with an embodiment of the present subject matter. The switched-capacitor integrator comprises a switch unit 100 for supplying a first or a second input voltage, Signal A or Signal B, to a first terminal 101 of capacitor 102, and for periodically supplying a third input voltage, Signal C, to a second terminal 103 of capacitor 102.

Switches 104, 105, 106, and 107 operate in response to clock signals, Φ₁ and Φ₂, such as shown in FIG. 9. Another switch 108 is connected between the terminal 109 and the terminal 114 of a reset capacitor 110. Switch 108 operates in response to clock signal CLEAR. Terminal 109 is also conductively coupled to the inverting input of op amp 112. The other terminal of reset capacitor 110 is conductively connected to the output terminal 114. Signal C is also supplied at the non-inverting input of opamp 112. An integration value is provided at the output terminal 114.

Signal A is defined as a main input signal, that is the signal for which the integrator circuit operates. Signal A may originate from a variety of sources depending on the function and type of physiological sensor incorporating the switched capacitor network. Signal B may be a function of Signal C. For example, Signal B=log(Signal C). Signal A may provide a voltage referenced to Signal B.

As mentioned before switches 104, 105, 106, and 107 operate in response to Φ₁ and Φ₂, which are the non-overlapping two-phase clock signals. The switches 105 and 107 operate in response to the first phase clock signal Φ₁ and the switches 104 and 106 operate in response to the second phase clock signal Φ₂.

When the second phase clock signal Φ₂ is enabled and, thus, the switches 104 and 106 are on, a charge is stored on capacitor 102. The charge applied across input capacitor 102 is the voltage difference between Signals C and B.

When the actuated clock signal changes from Φ₂ to Φ₁, the amount of charge stored in the capacitor 102 cannot change suddenly from and, therefore, the input capacitor 102 maintains an instant voltage. However, since the input voltage changes to a voltage of Signal A at the moment when the actuated clock signal becomes Φ₁, the voltage at the inverting terminal changes as a function of Signal A.

In a broad sense, the switched capacitor integrator includes an input capacitor and a plurality of switches controlling the voltages presented to a first terminal of the input capacitor. The voltages may be presented as Signals A and B. The switched capacitor integrator includes other switches controlling the voltage at the second terminal of the input capacitor. The second terminal is connected to a common terminal including a reset switch, a reset capacitor and an inverting input of an opamp. During one phase of operation, the terminals of the input capacitor are presented with the voltages of Signals B and C. During another phase of operation, one terminal of the input capacitor is presented with Signal A and the other terminal is conductively coupled to the inverting input of the opamp.

One potential method of operating the switched capacitor integrator includes defining a pair of clock signals, providing an input capacitor and a plurality of switches controlled in response to the pair of clock signals, wherein during a first phase of operation the input capacitor is charged to the difference between Signal B and C and during a second phase of operation one terminal of the input capacitor is connected to the main input signal, Signal A, and the other terminal is connected to the inverting input of the opamp. Signal C is always present at the noninverting terminal of the opamp. A reset capacitor and reset switch are connected between the inverting input and the opamp output. The reset capacitor is periodically reset in response to a reset signal. In one exemplary method of operation, Signals C and B are functions of each other.

Although the present subject matter and its advantages have been described in detail, it should be understood that various changes, substitutions and alterations can be made herein without departing from the spirit and scope of the subject matter. Moreover, the scope of the present application is not intended to be limited to the particular embodiments of the process, machine, manufacture, composition of matter, means, methods and steps described in the specification. As one of ordinary skill in the art will readily appreciate from the disclosure of the present subject matter, processes, machines, manufacture, compositions of matter, means, methods, or steps, presently existing or later to be developed that perform substantially the same function or achieve substantially the same result as the corresponding embodiments described herein may be utilized according to the present subject matter.

What is claimed is:

1. An apparatus comprising:
an operational amplifier;
a switched capacitor network coupled to an input terminal of the operational amplifier and coupled to an output terminal of the operational amplifier;
an optical sensor having a sensor output coupled to the switched capacitor network; and
a clock coupled to at least one switch of the switched capacitor network, the clock configured to activate the at least one switch to provide an integrated output at the output terminal corresponding to the sensor output.

2. The apparatus of claim 1 wherein the switched capacitor network includes at least one capacitor coupled to a switch.

3. The apparatus of claim 1 wherein the sensor output includes a pulse train.

4. The apparatus of claim 1 wherein the sensor output includes a sensor signal corresponding to a selected frequency of light.

5. The apparatus of claim 1 wherein the sensor output includes a sensor signal corresponding to a plurality of frequencies of light.

6. The apparatus of claim 1 wherein the sensor output corresponds to radiation in at least one of a red range and a near infrared range.

7. The apparatus of claim 1 wherein the clock includes a reset clock signal coupled to a reset switch of the switched capacitor network.

8. The apparatus of claim 7 wherein the reset switch is coupled in parallel with a feedback capacitor.

9. The apparatus of claim 8 wherein the feedback capacitor is coupled between the input terminal and the output terminal.

10. The apparatus of claim 1 wherein the clock includes a first clock signal and a second clock signal in which the first clock signal and the second clock signal are non-overlapping.

11. The apparatus of claim 10 wherein the first clock signal is coupled to a first input switch of the switched capacitor network and the second clock signal is coupled to a second input switch of the switched capacitor network.

12. A system comprising:
an integrating operational amplifier having a switched capacitor network coupled to an amplifier input and coupled to an amplifier output;
an optical sensor having a sensor output coupled to the switched capacitor network;
a clock coupled to the switched capacitor network, the clock configured to activate at least one switch of the switched capacitor network to provide an integrated output at the amplifier output corresponding to the sensor output; and
an output circuit coupled to the amplifier output, the output circuit including a display.

13. The system of claim 12 wherein the switched capacitor network includes a plurality of switches, each of which is coupled to the clock.

14. The system of claim 12 wherein the sensor output includes a signal corresponding to light of at least one of a red range and a near infrared range.

15. The system of claim 12 wherein the clock includes a first clock signal coupled to a reset switch of the switched capacitor network.

16. The system of claim 15 wherein the clock includes a first square wave signal in phase with the first clock signal.

17. The system of claim 16 wherein the clock includes a second square wave signal in phase with the first square wave signal.

18. The system of claim 17 wherein the second square wave signal is non-overlapping with the first square wave signal.

19. A method comprising:
receiving a pulsed signal from an optical sensor based on a tissue; integrating the pulsed signal using a switched capacitor network coupled to an operational amplifier; and
generating an output based on the integrated pulsed signal, the output corresponding to a physiological parameter for the tissue.

20. The method of claim 19 wherein receiving the pulsed signal includes receiving a signal corresponding to light of at least one of a red range and an infrared range.

21. The method of claim 19 wherein integrating the pulsed signal includes actuating at least one switch of the switched capacitor network using a clock signal.

22. The method of claim 19 wherein generating the output includes displaying a measure of oximetry.
